(19) United States
(12) Patent Application Publication
(10) Pub. No.: US 2026/0268608 A1
(43) Pub. Date: Sep. 10, 2026

(54) EFFECT EDITING

(71) Applicant: Bytedance Technology Ltd., Grand Cayman (CY)

(72) Inventors: Xiaoke HUANG, Culver City, CA (US); Jie LI, Los Angeles, CA (US); Junhao HUANG, Culver City, CA (US); Tianyu YANG, Los Angeles, CA (US); Jeffrey Chifang MA, Culver City, CA (US); Kewei CHEN, Beijing (CN); Qi ZHANG, Culver City, CA (US); Luqi NIE, Beijing (CN); Longze XIA, Beijing (CN); Haozheng LIANG, Los Angeles, CA (US)

(21) Appl. No.: 19/542,636

(22) Filed: Feb. 17, 2026

(30) Foreign Application Priority Data
Mar. 10, 2025 (CN) 202510279344.9

(51) Int. Cl. G06T 19/00; G06F 3/04815; G06F 3/04847

(52) U.S. Cl. CPC G06T 19/00; G06F 3/04815; G06F 3/04847

(57) ABSTRACT

A method, a device, and a storage medium for effect editing are provided. The method includes: presenting an interaction window in response to receiving a first operation in an effect editing interface; determining at least one generation parameter via at least one parameter configuration control in the interaction window; presenting, in the interaction window, first media content generated based on the at least one generation parameter; and applying generation configuration information to a virtual asset in the effect editing interface in response to receiving a second operation in the interaction window, the generation configuration information corresponding to the at least one generation parameter.

### CROSS-REFERENCE

This application claims the benefit of Chinese Patent Application No. 202510279344.9, filed on Mar. 10, 2025, and entitled “METHOD, APPARATUS, DEVICE FOR EFFECT EDITING, AND STORAGE MEDIUM”, which is hereby incorporated by reference in its entirety.

### FIELD

Example embodiments of the present disclosure generally relate to the field of computers, and in particular, to effect editing.

### BACKGROUND

Effect editing is an indispensable part of digital entertainment fields such as film and television production and game development. With the continuous development of computer graphics, digital image processing, and artificial intelligence technologies, effect creators can edit and adjust styles of effects with high precision and a high degree of freedom.

### SUMMARY

In a first aspect of the present disclosure, a method for effect editing is provided. The method includes: presenting an interaction window in response to receiving a first operation in an effect editing interface; determining at least one generation parameter via at least one parameter configuration control in the interaction window; presenting, in the interaction window, first media content generated based on the at least one generation parameter; and applying generation configuration information to a virtual asset in the effect editing interface in response to receiving a second operation in the interaction window, the generation configuration information corresponding to the at least one generation parameter.

In a second aspect of the present disclosure, an apparatus for effect editing is provided. The apparatus includes: a first presentation module configured to present an interaction window in response to receiving a first operation in an effect editing interface; a determination module configured to determine at least one generation parameter via at least one parameter configuration control in the interaction window; a second presentation module configured to present, in the interaction window, first media content generated based on the at least one generation parameter; and a first application module configured to apply generation configuration information to a virtual asset in the effect editing interface in response to receiving a second operation in the interaction window, the generation configuration information corresponding to the at least one generation parameter.

In a third aspect of the present disclosure, an electronic device is provided. The electronic device includes at least one processor; and at least one memory. The at least one memory is coupled to the at least one processor and stores instructions executable by the at least one processor, and the instructions, when executed by the at least one processor, cause the electronic device to perform the method of the first aspect.

In a fourth aspect of the present disclosure, a non-transitory computer-readable storage medium is provided. The non-transitory computer-readable storage medium has a computer program stored thereon, and the computer program is executable by a processor to perform the method of the first aspect.

It would be appreciated that the content described in the Summary section of the present disclosure is neither intended to identify key or essential features of embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference numbers refer to the same or similar elements, where:

FIG. 1 shows a schematic diagram of an example environment in which embodiments according to the present disclosure may be implemented;

FIG. 2A to FIG. 2L show example interfaces according to some embodiments of the present disclosure;

FIG. 3 shows a flowchart of an example process of effect editing according to some embodiments of the present disclosure;

FIG. 4 shows a schematic structural block diagram of an example apparatus for effect editing according to some embodiments of the present disclosure; and

FIG. 5 shows a block diagram of an electronic device capable of implementing multiple embodiments of the present disclosure.

### DETAILED DESCRIPTION

Embodiments of the present disclosure are described in more detail below with reference to the drawings. Although some embodiments of the present disclosure are shown in the drawings, it would be appreciated that the present disclosure may be implemented in various forms and should not be construed as limited to the embodiments set forth herein. Instead, these embodiments are provided for a more thorough and complete understanding of the present disclosure. It would be appreciated that the drawings and embodiments of the present disclosure are only used for illustrative purposes, and are not used to limit the protection scope of the present disclosure.

It should be noted that the titles of any section/subsection provided herein are not restrictive. Various embodiments are described throughout this specification, and any type of embodiment may be included under any section/subsection. In addition, the embodiments described in any section/subsection may be combined with any other embodiments described in the same section/subsection and/or different section/subsection in any way.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other definitions, either explicitly or implicitly, may also be included below. The terms “first”, “second”, etc. may refer to different or same objects. Other definitions, either explicit or implicit, may also be included below.

The embodiments of the present disclosure may involve user data, data acquisition and/or use, etc. All these aspects comply with corresponding laws, regulations and related provisions. In the embodiments of the present disclosure, all data collection, acquisition, processing, manipulating, forwarding, use, etc. are carried out on the premise that the user is aware of and confirms. Accordingly, when implementing the embodiments of the present disclosure, the user should be informed of the type, range of use, use scenarios, etc. of the data or information that may be involved, and the authorization of the user should be obtained in an appropriate manner according to relevant laws and regulations. The specific manner of informing and/or authorizing may vary according to the actual situation and application scenarios, and the scope of the present disclosure is not limited in this regard.

If the solutions in this specification and the embodiments involve personal information processing, the processing will be carried out on the premise that there is a legal basis (for example, the consent of the personal information subject is obtained, or it is necessary to perform a contract, etc.), and the processing will only be carried out within the scope of provisions or agreements. If the user refuses to process personal information other than the necessary information required for the basic functions, it will not affect the user's use of the basic functions.

As mentioned above, effect editing is an indispensable part of digital entertainment fields such as film and television production and game development. With the continuous development of computer graphics, digital image processing, and artificial intelligence technologies, effect creators may edit and adjust styles of effects with high precision and a high degree of freedom.

An embodiment of the present disclosure proposes a solution for effect editing. The solution includes: presenting an interaction window in response to receiving a first operation in an effect editing interface; determining at least one generation parameter via at least one parameter configuration control in the interaction window; presenting, in the interaction window, first media content generated based on the at least one generation parameter; and applying generation configuration information to a virtual asset in the effect editing interface in response to receiving a second operation in the interaction window, the generation configuration information corresponding to the at least one generation parameter.

The embodiments of the present disclosure can conveniently construct generation configuration information through independent interaction creation, and can apply the generation configuration information to an effect editing process. In this way, the embodiments of the present disclosure can improve the efficiency of effect editing, and enrich the styles applied in the effect creation process.

Various example implementations of this solution are described in detail below with further reference to the drawings.

### Example Environment

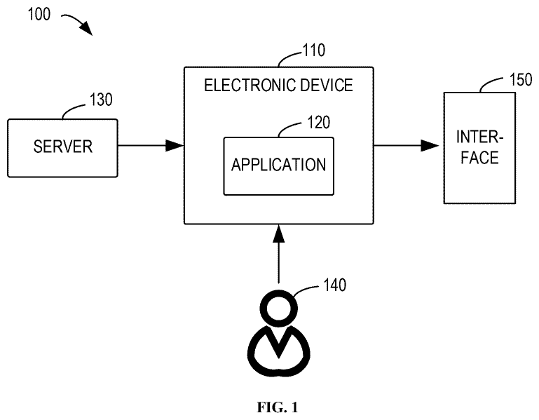

FIG. 1 shows a schematic diagram of an example environment 100 in which the embodiments of the present disclosure may be implemented. As shown in FIG. 1, the example environment 100 may include an electronic device 110.

In this example environment 100, the electronic device 110 may run an application 120 supporting effect editing. The application 120 may be any appropriate type of application for effect editing, examples of which may include but be not limited to an effect editing application or other appropriate applications. A user 140 may interact with the application 120 via the electronic device 110 and/or its attached devices.

In the environment 100 of FIG. 1, if the application 120 is active, the electronic device 110 may present an interface 150 for supporting effect editing through the application 120.

In some embodiments, the electronic device 110 communicates with a server 130 to implement the supply of services of the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a TV receiver, a radio broadcast receiver, an e-book device, a game device, or any combination of the foregoing, including fittings and peripherals of these devices or any combination thereof. In some embodiments, the electronic device 110 may also support any type of user-specific interface (such as a “wearable” circuit, etc.).

The server 130 may be an independent physical server, a server cluster or distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and so on. The server 130 may provide backstage services for the application 120 supporting effect editing in the electronic device 110.

A communication connection may be established between the server 130 and the electronic device 110. The communication connection may be established by wired or wireless means. The communication connection may include but be not limited to a Bluetooth connection, a mobile network connection, a universal serial bus (USB) connection, a wireless fidelity (WiFi) connection, etc., and the embodiments of the present disclosure are not limited in this regard. In the embodiments of the present disclosure, the server 130 and the electronic device 110 may implement signaling interaction through the communication connection therebetween.

It would be appreciated that the structure and functions of various elements in the environment 100 are described for illustrative purposes only, without suggesting any limitation to the scope of the present disclosure.

Some example embodiments of the present disclosure are described below with continued reference to the drawings.

### Example 1

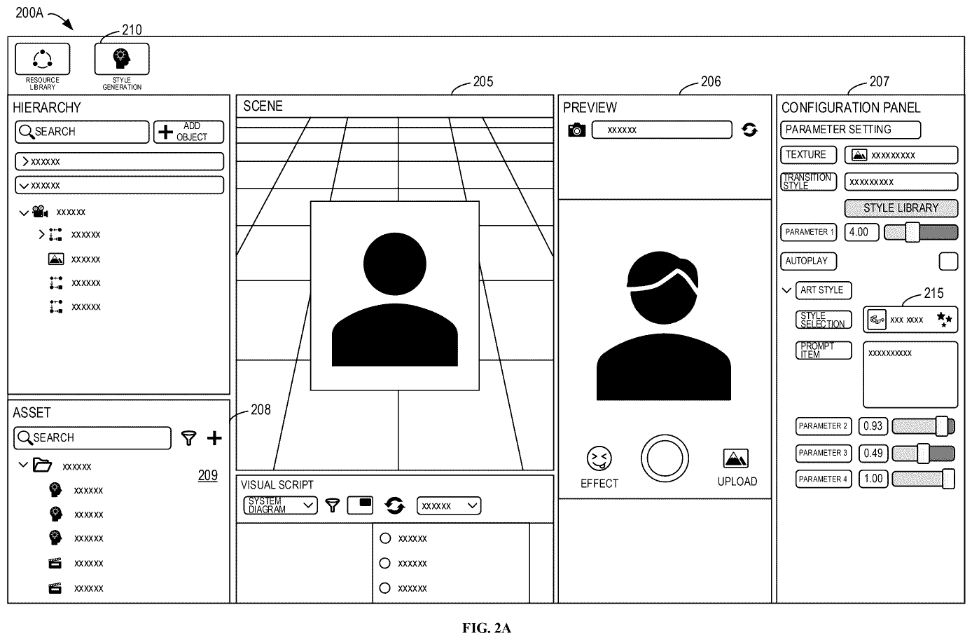

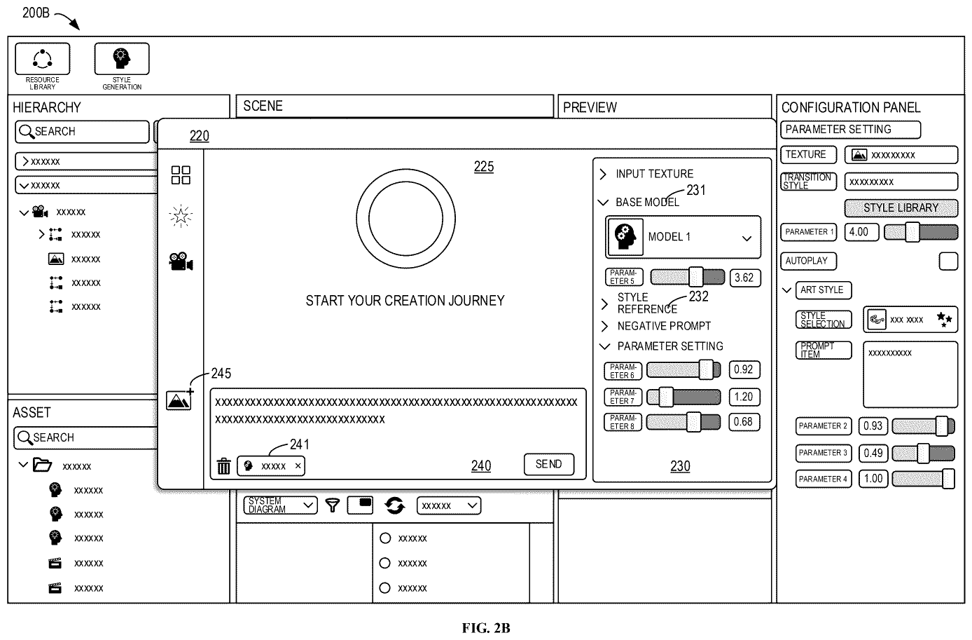

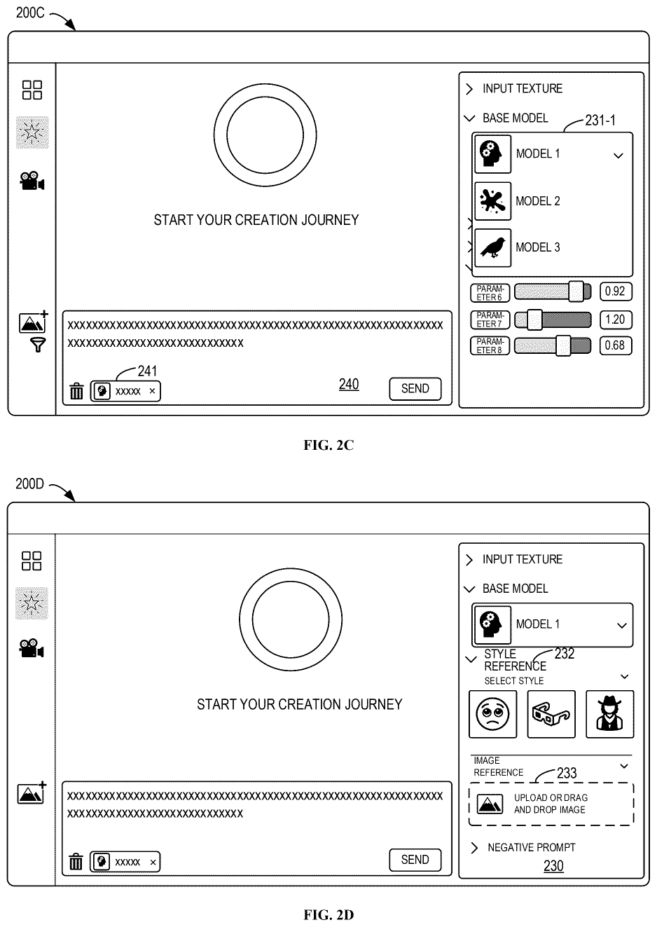

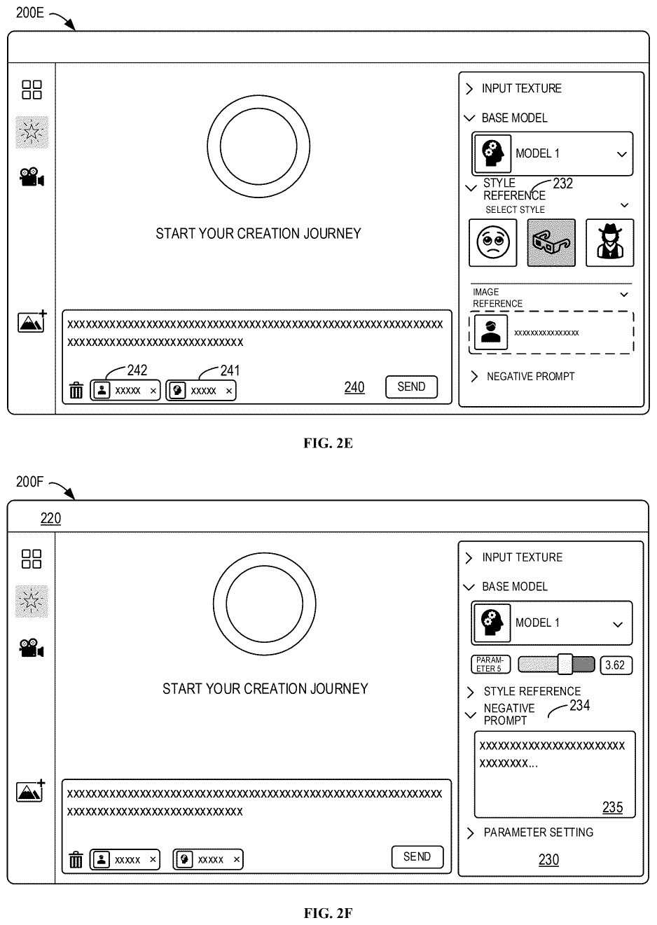

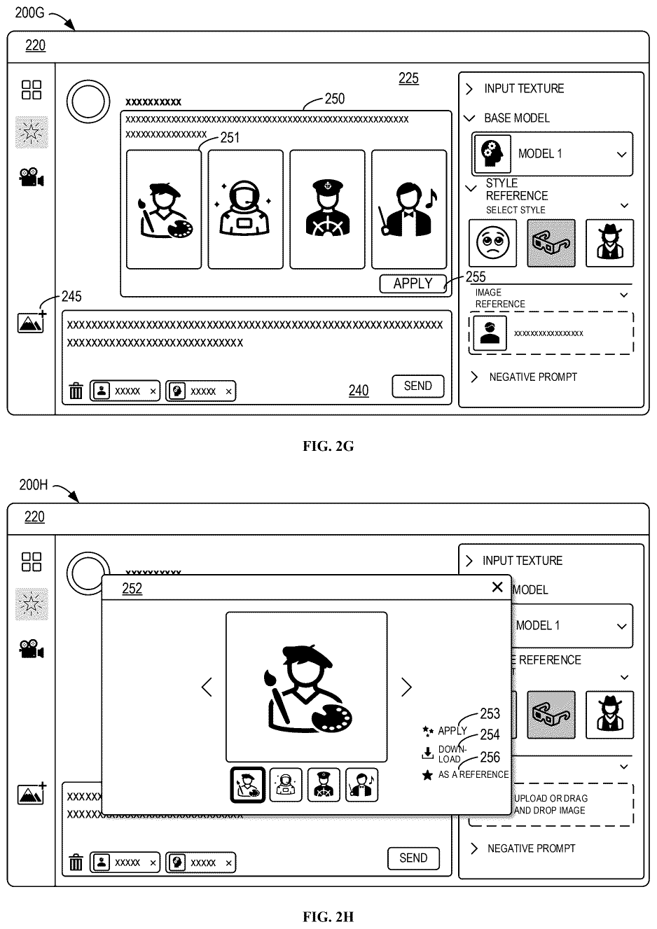

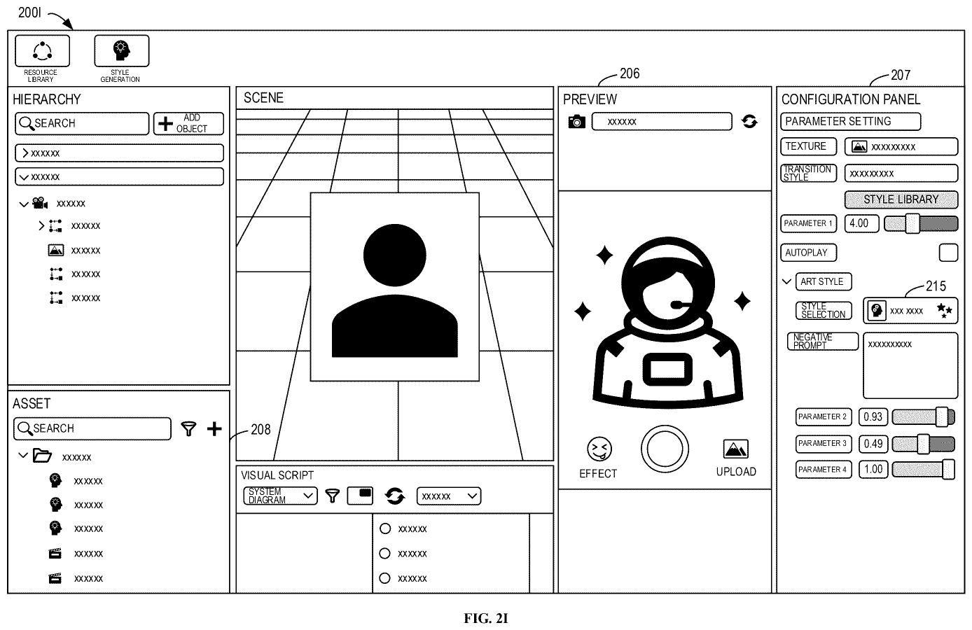

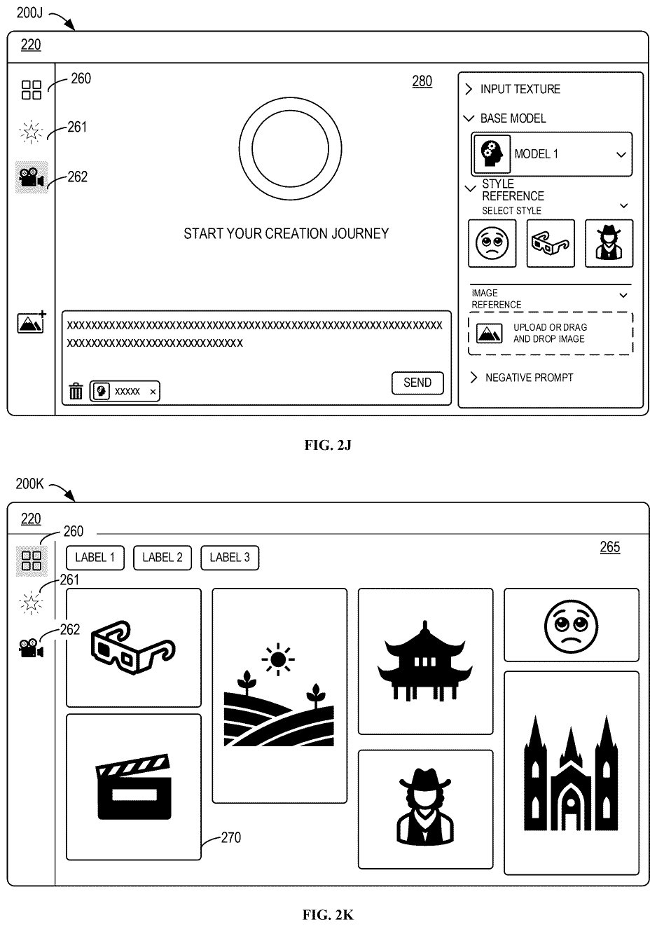

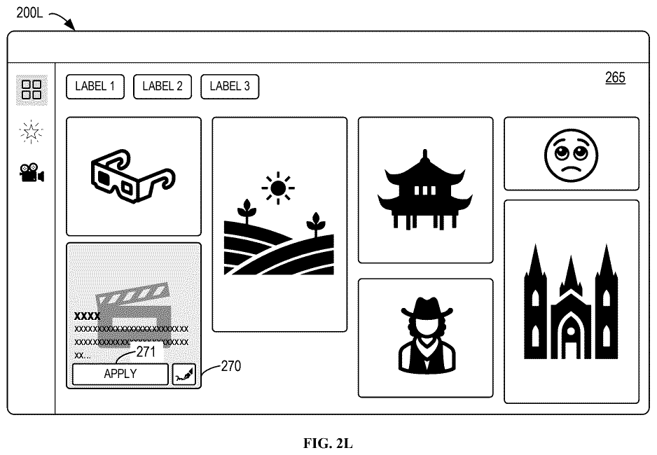

FIG. 2A to FIG. 2L show example interfaces 200A to 200L according to some embodiments of the present disclosure. The interfaces 200A to 200L may be provided, for example, by the electronic device 110 shown in FIG. 1.

In some embodiments, the electronic device 110 may receive an effect editing request triggered by the user 140 to provide the user 140 with an effect editing interface 200A. The interface 200A may be provided, for example, by an effect editing application. The effect editing application may be an effect creation tool provided for effect developers, which may support the effect developers to create, edit, and post effect files.

As an example, the effect file may be posted or applied to a media application to support users to use corresponding effect resources in the media application, so as to trigger the application of corresponding effects. For example, the effect file may include code for triggering the application of a specific filter to a captured or uploaded image.

In the effect editing process, a media generation style is an important attribute. For example, in the effect editing application, a corresponding media generation style may be applied to a virtual asset in a project. As an example, the virtual material may include an image material, a video material, a model material, a map material, and the like. Correspondingly, during the running of the effect file, the virtual asset may trigger the generation of corresponding media content based on the configured basic texture (for example, the captured image or the uploaded image) and media generation style. The generated media content may be provided as part of the effect, for example, some effects may present a transition process from the captured image to the generated image.

The specific process of how to create and apply the media generation style in the effect editing scene is described in detail below.

As shown in FIG. 2A, the interface 200A may provide a scene editing panel 205 and a preview component 206. The scene editing panel 205 is configured to support receiving the editing by the user 140 on a scene associated with the effect file to be edited. For example, the scene editing panel 205 may support editing a virtual scene corresponding to the effect in a two-dimensional way or a three-dimensional way. In addition, the preview component 206 is configured to support a preview effect of the effect currently being edited.

In addition, the interface 200A may further include an asset panel 208, which may display virtual assets added to an editing project corresponding to the interface 200A such as materials, textures, images, etc.

As shown in FIG. 2A, the electronic device 110 may further receive the selection a specific virtual asset in the interface 200A by the user, and may present a setting panel 207 corresponding to the virtual asset. As shown in the figure, the setting panel 207 may provide a plurality of setting controls for setting different parameters of the virtual asset.

In some examples, if the parameter of the selected virtual asset includes a media generation style, the setting panel 207 is used to configure a generation control 215 of the media generation style corresponding to the virtual asset. For example, in a media editing scene, an intelligent texture is a virtual asset that supports the configuration of a media generation style. It may set a basic texture and a media generation style to trigger the generation of corresponding media content based on the configured basic texture and the media generation style, which then serves as the content of the intelligent texture. As an example, the generation control 215 may present description information, such as a style name and a style icon, of a current media generation style applied to the intelligent texture.

In addition, the electronic device 110 may further provide a generation tool 210 in the editing interface 200A, which may independently trigger the presentation of an interaction window as described below. As another example, the electronic device 110 may also receive a trigger on the generation control 215 and present an interaction window as described below.

In some embodiments, in a case where the presentation of the interaction window is triggered through the generation tool 210, the generation configuration information constructed via the interaction window will trigger the addition of a preset virtual asset in the editing interface, and the constructed generation configuration information may be applied to the added virtual asset.

On the contrary, in a case where the presentation of the interaction window is triggered through the generation control 215, the generation configuration information constructed via the interaction window will be applied to the virtual asset corresponding to the generation control 215.

The specific process of constructing and applying the generation configuration information through the interaction window is described in detail below.

The “generation configuration information” in the present disclosure may correspond to different media generation styles. As an example, such styles may include but be not limited to a visual style, a content style, a language style, etc. of the media content. As an example, the visual style may include, for example, a color style, an animation style, a filter style, etc. The content style may include, for example, an active style, a serious style, etc. The language style may include a formal style, a funny style, etc.

As shown in FIG. 2B, the interaction window 220 triggered and presented via the generation tool 210 or the generation control 215 may include a first page 225. The first page 225 may include a plurality of parameter configuration controls. For example, the first page 225 may include at least one parameter configuration control in a parameter configuration panel 230 and a parameter configuration control located outside the parameter configuration panel 230, such as a prompt input control 240.

The electronic device 110 may determine at least one generation parameter via the parameter configuration panel 230 and the prompt input control 240. As an example, such at least one generation parameter may include a prompt entered by the user via the prompt input control 240.

In addition, such at least one generation parameter may further include at least one additional generation parameter configured by the user through one or more parameter configuration controls in the parameter configuration panel 230. As an example, the at least one additional generation parameter may include but be not limited to: a base model, a reference image, a negative prompt, a style strength, a visual similarity, etc.

In some embodiments, in the case where the configured base models are different, the types of parameter configuration controls provided in the parameter configuration panel 230 may, for example, also be dynamically changed. Therefore, different types of configurable parameters may be set for different models. Such information may be dynamically sent by the server 130 to the application 120, to enable support for more models without updating the version of the application 120.

For example, in the case where the platform supports a new base model, the server 130 may send relevant information of the base model to the application 120 to support the selection of the supported new base model in the parameter configuration panel 230.

In some embodiments, the electronic device 110 may determine at least one generation parameter via a parameter configuration control in the parameter configuration panel 230. In addition, after determining the at least one generation parameter, the electronic device 110 may further present an indication element 241 in the prompt input control 240. The indication element 241 may be used, for example, to represent the determined at least one generation parameter. In this way, the embodiments of the present disclosure can enable the user to perceive the configured generation parameter more efficiently, thereby improving the efficiency of style generation.

In some embodiments, the parameter generation panel 230 may include a first control 231 for setting a base model, for example, in a case where the user sets the base model to “Model 1” via the first control 231. The indication element 241 may, for example, present identification information (for example, a name or an icon of the model) of the model (for example, “Model 1”) determined via the first control 231.

Specifically, as shown in FIG. 2C, the electronic device 110 may present a model selection bar 231-1 in response to receiving a click from the user 140 on the first control 231. Further, the model selection bar 231-1 may display a plurality of preset base models supported by the application 120, such as Model 1, Model 2, and Model 3. Such preset base models may, for example, correspond to models of different styles, models of different performances, models of different scales, etc.

Further, as shown in FIG. 2C, after receiving the selection of “Model 1”, the electronic device 110 may present the indication element 241 corresponding to “Model 1” in the prompt input control 240. The indication element 241 includes identification information associated with the selected model (i.e., Model 1), and such identification information may include, for example, an image identification (for example, an icon of Model 1) and a text identification (for example, a name of Model 1).

In this way, the embodiments of the present disclosure support the user 140 to select an appropriate model through the control in the interaction panel, thereby improving the quality of subsequent determined generation configuration information.

In some embodiments, as shown in FIG. 2D, the parameter configuration panel 230 may further include a style reference control 232. After the style reference control 232 is selected, the electronic device 110 may present a second control 233 for setting a reference image in the parameter configuration panel 230 (i.e., the parameter configuration panel). The second control 233 is configured to acquire a reference image uploaded by the user 140. As an example, the user may click the second control 233 to select the reference image; or the user may also drag the reference image into the second control 233.

Further, as shown in FIG. 2E, after the reference image is added via the second control 233, the electronic device 110 may present an indication element 242 in the prompt input control 240. The indication element 242 includes an image identification and/or a text identification associated with the added reference image. The image identification may be, for example, preview content in the reference image, and the text identification may be, for example, a file name of the reference image. In this way, the embodiments of the present disclosure can support the user 140 to acquire the reference image for constructing the at least one generation parameter via the second control, thereby improving the efficiency of effect editing.

In some embodiments, in order to make it more convenient for the user 140 to edit the style, the electronic device 110 may adjust a configuration state of a target parameter configuration control in response to an interaction operation of the user 140 on the indication element 241 or the indication element 242. Such an interaction operation may be, for example, a removal operation. Specifically, the electronic device 110 may adjust the configuration state of the corresponding parameter configuration control in response to receiving the removal operation for the indication element.

As an example, as shown in FIG. 2E, when the electronic device 110 receives the removal operation on the indication element 241, the electronic device 110 may stop presenting the indication element 241 in the prompt input control 240. Further, when the indication element 241 is no longer presented, the electronic device 110 may cancel the selection of “Model 1”. In this way, the selection of the model can be quickly modified, thereby improving the efficiency of effect editing.

In some scenarios, the electronic device 110 may further receive the removal operation of the user 140 on the indication element 242. After the removal operation on the indication element 242 is received, the electronic device 110 may cancel the presentation of the indication element 242 in the prompt input control 240, and clear the corresponding reference image added via the second control 233. In this way, the embodiments of the present disclosure may remove the reference image more conveniently, thereby improving the efficiency of effect editing.

In addition, or alternatively, the electronic device 110 may further receive a selection operation of the user 140 on the indication element, to present in the interaction window 220 description information of a target generation parameter corresponding to the indication element. Taking the indication element 241 being selected as an example, when hovering over the indication element 241, the electronic device 110 may, for example, present detailed information of “Model 1”.

In some embodiments, as shown in FIG. 2E, the electronic device 110 may also select a preset reference style via the style reference control 232, to serve as a generation parameter. In some embodiments, such a preset reference style may include different low-rank adaptation (LoRa) styles.

In some embodiments, as shown in FIG. 2F, the electronic device 110 may further provide a control 234 in the parameter configuration panel 230. The control 234 is configured to acquire a negative prompt 235 entered by the user 140. The negative prompt 235 may indicate, for example, a part that is not included in the generation configuration information determined subsequently. For example, the negative prompt item may be “no text should appear”.

In addition, or alternatively, the electronic device 110 may further provide a plurality of parameter adjustment controls in the parameter configuration panel 230. Such parameter adjustment controls may be used, for example, to adjust parameters such as style strength and style adaptability. The specific parameters may be set by those skilled in the art, and the present disclosure does not limit them. The electronic device 110 may acquire some parameters in the at least one generation parameter via a plurality of parameter adjustment controls in the parameter configuration panel 230.

In this way, the electronic device 110 may determine at least one generation parameter via at least one parameter configuration control provided in the interaction panel 220, to trigger the generation of corresponding media content.

In some embodiments, after the at least one generation parameter is determined, the electronic device 110 may receive the click of the user on the sending button in the prompt input control 240, and trigger a corresponding media generation request. Further, as shown in FIG. 2G, the electronic device 110 may present a response message 250 corresponding to the at least one generation parameter determined in the interaction window 220.

As shown in the figure, the response message 250 may include one or more media content generated based on the group of generation parameters, e.g., media content 251 (also referred to as first media content). In addition, in addition to the media content 251, the response message 250 may also, for example, present at least a part of the group of generation parameters, such as a prompt.

In some embodiments, the media content 251 may be generated, for example, using the configured model and based on the base media content (also referred to as second media content) and the group of generation parameters. In some scenarios, the base media content may include preset media content and/or user-configured media content.

Taking an image being generated based on an image as an example, such base media content may include a preset base image, and the media content 251 may include an image generated based on the group of generation parameters and the base image.

In some embodiments, the electronic device 110 may acquire the base media content configured by the user 140 through the media configuration entry 245, and such base media content may be, for example, the media content uploaded by the user 140. Specifically, the electronic device 110 may present the media configuration interface in response to the selection of the media configuration entry in the interaction window. Further, the electronic device 110 may determine the base media content via the media configuration interface.

As an example, after the media configuration entry 245 is selected, the electronic device 110 may present the media configuration interface. The electronic device 110 may provide a media upload entry for the user in the media configuration interface, and the electronic device 110 may acquire the base media content uploaded by the user 140 via the media upload entry.

In some embodiments, the electronic device 110 may acquire the base media content selected by the user 140. For example, the base media content may include at least one piece of media content selected by the user from a preset group of candidate media content. Specifically, the electronic device 110 may present a group of candidate media content. Further, the electronic device 110 may receive the selection of the base media content in the group of candidate media content.

In some embodiments, as shown in FIG. 2H, after the first media content 251 is clicked, the electronic device 110 may present the viewing component 252 in the interaction window 220. The viewing component 252 is used to view a group of media content in the first response message 250. The viewing window 252 includes a control 253 and a control 254. After the control 253 is selected, the electronic device 110 may apply the generation configuration information corresponding to the at least one generation parameter for generating the first media content 251 to the virtual asset in the effect editing interface. After the control 254 is selected, the electronic device 110 may download the media content being viewed (for example, the first media content 251).

In some embodiments, the electronic device 110 applies the generation configuration information to the virtual asset in the effect editing interface in response to receiving the second operation in the interaction window. Specifically, the generation configuration information may correspond to the at least one generation parameter for generating the first media content 251.

As an example, as shown in FIG. 2G, the electronic device 110 may provide a control 255 in the first response message 250. After the control 255 is clicked by the user 140 (i.e., the second operation), the electronic device 110 may determine the generation configuration information based on the at least one generation parameter acquired, and apply the generation configuration information to the virtual asset in the effect editing interface.

As described above, if the interaction window is triggered via the generation tool 210, the electronic device 110 may add a virtual asset of a preset type in the effect editing interface in response to receiving the second operation. Further, the electronic device 110 may apply the generation configuration information to the added virtual asset. As an example, as shown in FIG. 2G, after the electronic device 110 receives the selection of the control 255 by the user 140, the electronic device 110 may add a virtual asset of a preset type in the asset panel 208 in the effect editing interface. Such a virtual asset may be, for example, an intelligent texture. Further, the electronic device 110 may apply the generation configuration information to the added intelligent texture.

As described above, if the interaction window is triggered via the generation control 215 in the setting panel 207, the electronic device 110 may also apply the generation configuration information to the virtual asset corresponding to the generation control 215. Further, the generation control 215 may be updated to display options corresponding to the generation configuration information applied, such as a style name and a style icon.

As an example, as shown in FIG. 2I, after the generation configuration information is applied to the virtual asset, the electronic device 110 may receive an effect file creation request triggered by the user 140. After receiving the effect file creation request, the electronic device 110 creates the effect file via the effect editing interface.

Further, the electronic device 110 may further receive an effect file application request triggered by the user 140. After receiving the effect file application request, the electronic device 110 may present the usage effect of the effect file in the preview component 206. Such a usage effect includes at least the media content generated based on the at least one generation parameter.

In some embodiments, during the running of the created effect file, the effect file may call a media generation service based on the at least one generation parameter corresponding to the generation configuration information to generate corresponding media content.

After determining the at least one generation parameter, the embodiments of the present disclosure may present in the interaction window the first media content generated based on the at least one generation parameter, and receive the first operation via the interaction window to apply the generation configuration information to the virtual asset. In this way, the embodiments of the present disclosure can effectively improve the efficiency of effect editing.

### Example 2

The process of constructing and applying the generation configuration information is described above by using the image generation configuration information for controlling the image.

In some embodiments, the electronic device 110 further supports the user 140 to generate video generation configuration information for processing a video via the interaction window 220. For example, the at least one generation parameter for generating the first media content described above may be a first group of generation parameters, the generation configuration information corresponding to the first group of generation parameters may be, for example, the image generation configuration information, and the first media content includes image content. Specifically, the electronic device 110 may associate the image content with a second group of generation parameters for generating video content in response to receiving a third operation on the image content. Further, the electronic device 110 may present in the interaction window video content generated based on the image content and the second group of generation parameters. The second group of generation parameters corresponds to the video generation configuration information.

As an example, as shown in FIG. 2H, the electronic device 110 may receive a click operation (i.e., the third operation) from the user 140 on a control 256 in the viewing component 252. After the third operation is received, the electronic device 110 may associate the image content of the first media content 251 with the second group of generation parameters for generating the video content. As an example, after the third operation is received, the electronic device 110 may use the image content of the first media content 251 as a reference image for generating the video content, so as to determine the second group of generation parameters based on the reference image.

Further, after the second group of generation parameters is determined, the electronic device 110 may present a second response message in the interaction window 220. The second response message includes a plurality of video content. The plurality of video content is generated based on the second group of generation parameters. After the confirmation control in the second response message is selected, the electronic device 110 may determine the video generation configuration information based on the second group of generation parameters.

In some scenarios, as shown in FIG. 2J, the electronic device 110 may provide a control 260, a control 261, and a control 262 for the user in the interaction window 220. The control 260 is associated with a style selection page, and the style selection page includes a plurality of generation templates. The control 261 is associated with the page 225, and the page 225 is used to determine the image generation configuration information. The control 262 is associated with a page 280, and the page 280 is used to determine the video generation configuration information.

After the control 262 is selected, the electronic device 110 may present the page 280 in the interaction window 220. The electronic device 110 may acquire the second generation parameter for determining the video generation configuration information via the page 280. The process of determining the video generation configuration information is similar to the process of determining the image generation configuration information described above, and the details are not repeated in the present disclosure.

### Example 3

In some embodiments, the electronic device 110 may further provide a plurality of preset generation templates for the user, so as to determine the preset generation configuration information through the generation templates and apply the preset generation configuration information to the virtual asset. Specifically, the electronic device 110 may present a plurality of generation templates in the interaction window in response to receiving a fourth operation in the interaction window, each generation template corresponding to preset generation configuration information.

As an example, as shown in FIG. 2J and FIG. 2K, the electronic device 110 may provide a plurality of controls in the interaction window 220. The plurality of controls may include, for example, a control 260, and the control 260 is associated with the style selection page. After the control 260 is selected (i.e., the fourth operation), the electronic device 110 may present the style selection page 265 in the interaction window 220. The style selection page 265 includes a plurality of preview elements, and the plurality of preview elements may be associated with a plurality of generation templates, respectively, each generation template may correspond to different preset generation configuration information. The preview element includes an image identification and a text identification, the image identification indicates the cover image of the generation template associated with the preview element, and the text identification indicates the name of the generation template associated with the preview element.

After the target preview element 270 in the plurality of preview elements is selected, the electronic device 110 may present the interactive panel shown in FIG. 2L in the target preview element 270. Such an interactive panel may include, for example, a control 271. The control 271 is configured to apply the generation configuration information corresponding to the target preview element 270 to the virtual asset in the effect editing interface. For example, after the control 271 is selected, the electronic device 110 may acquire the generation configuration information associated with the target preview element 270. Further, the electronic device 110 may apply the generation configuration information to the virtual asset in the effect editing interface.

### Example Process

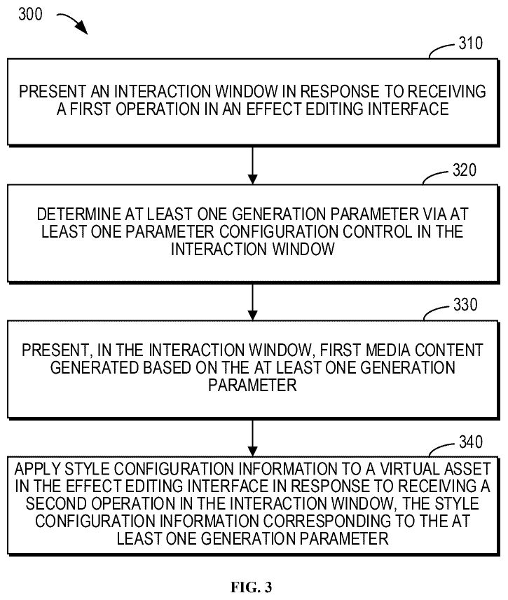

FIG. 3 shows a flowchart of an example process 300 of effect editing according to some embodiments of the present disclosure. The process 300 may be implemented at the electronic device 110. The process 300 is described below with reference to FIG. 1.

As shown in FIG. 3, at block 310, the electronic device 110 presents an interaction window in response to receiving a first operation in an effect editing interface.

At block 320, the electronic device 110 determines at least one generation parameter via at least one parameter configuration control in the interaction window.

At block 330, the electronic device 110 presents, in the interaction window, first media content generated based on the at least one generation parameter.

At block 340, the electronic device 110 applies generation configuration information to a virtual asset in the effect editing interface in response to receiving a second operation in the interaction window, the generation configuration information corresponding to the at least one generation parameter.

In some embodiments, the at least one parameter configuration control includes a prompt input control, and the at least one generation parameter includes a prompt entered via the prompt input control.

In this way, the embodiments of the present disclosure can determine the generation configuration information based on the prompt entered by the user, thereby improving the efficiency of the determination of the generation configuration information.

In some embodiments, the interaction window further includes a parameter configuration panel presenting a target parameter configuration control in the at least one parameter configuration control, and the process 300 further includes: determining a target generation parameter via the target parameter configuration control; and presenting an indication element corresponding to the target generation parameter in the prompt input control.

In this way, the embodiments of the present disclosure can present the indication element corresponding to the target generation parameter in the prompt input control, which can enable the user to view the target generation parameter more intuitively, thereby improving interaction experience of the user.

In some embodiments, the process 300 further includes: adjusting a configuration state of the target parameter configuration control in response to receiving a removal operation for the indication element.

In this way, the embodiments of the present disclosure can quickly adjust the configuration state of the target parameter configuration control based on the adjustment of the indication element, thereby improving the efficiency of effect editing.

In some embodiments, the target parameter configuration control includes a first control for selecting a model, and the indication element presents identification information of the model determined via the first control.

In this way, the embodiments of the present disclosure can enable the user to select an appropriate model through the control in the interaction panel, thereby improving the quality of subsequent determined generation configuration information.

In some embodiments, the target parameter configuration control includes a second control for setting a reference image, and the indication element presents preview content of at least one reference image configured via the second control.

In this way, the embodiments of the present disclosure can support the user to acquire the reference image for constructing the at least one generation parameter via the second control, thereby improving the efficiency of effect editing.

In some embodiments, the prompt input control is located outside the parameter configuration panel.

In this way, the embodiments of the present disclosure can make the parameter configuration panel more concise, thereby improving interaction experience of the user.

In some embodiments, presenting in the interaction window the first media content generated based on the at least one generation parameter includes: presenting, in the interaction window, a response message corresponding to the at least one generation parameter, the response message presenting the first media content and at least a part of the at least one generation parameter.

In this way, the embodiments of the present disclosure can support providing the response message to the user through a dialogue, which not only improves interaction experience of the user, but also improves the efficiency of effect editing.

In some embodiments, the first media content is generated based on second media content and the at least one generation parameter, and the second media content includes at least one of: preset media content; or user-configured media content.

In this way, the embodiments of the present disclosure can support the user to select appropriate second media content to generate the first media content, thereby improving the generation quality of the first media content.

In some embodiments, the process 300 further includes: presenting a media configuration interface in response to the selection of a media configuration entry in the interaction window; and determining a second media content via the media configuration interface.

In this way, the embodiments of the present disclosure can manage the second media content through the media configuration interface, thereby improving the management efficiency of the second media content.

In some embodiments, determining the second media content via the media configuration interface includes: presenting a group of candidate media content; and receiving a selection of the second media content in the group of candidate media content.

In this way, the embodiments of the present disclosure can provide a group of candidate media content for the user to select, thereby improving the efficiency of the user to select the second media content, and further improving the efficiency of effect editing.

In some embodiments, the first operation includes a selection of a generation tool in the effect editing interface, and applying the generation configuration information to the virtual asset in the effect editing interface in response to receiving the second operation in the interaction window includes: adding a virtual asset of a preset type in the effect editing interface in response to receiving the second operation; and applying the generation configuration information to the added virtual asset.

In this way, the embodiments of the present disclosure can effectively optimize the process of effect editing and reduce the time of effect editing, thereby improving the efficiency of effect editing.

In some embodiments, presenting the interaction window in response to receiving the first operation in the effect editing interface includes: presenting a setting panel of a virtual asset in response to a selection of the virtual asset in the effect editing interface; and presenting the interaction window in response to a selection of a generation control in the setting panel.

In this way, the embodiments of the present disclosure can provide a plurality of generation entrances for the user, so that the user may select a more convenient entrance to start style editing, which can reduce the operation time of the user, thereby improving the efficiency of effect editing.

In some embodiments, applying the generation configuration information to the virtual asset in the effect editing interface in response to receiving the second operation in the interaction window includes: presenting an option corresponding to the generation configuration information in the generation control in response to receiving the second operation.

In this way, the embodiments of the present disclosure can enable the user to view the option corresponding to the generation configuration information during the effect editing process, which can effectively assist the user to perform effect editing, thereby improving the efficiency of effect editing.

In some embodiments, the first media content includes image content, the at least one generation parameter is a first group of generation parameters, the generation configuration information is configuration information of image generation, and the method further includes: associating the image content with a second group of generation parameters for generating video content in response to receiving a third operation on the image content; and presenting, in the interaction window, the video content generated based on the image content and the second group of generation parameters, the second group of generation parameters corresponding to configuration information of video generation.

In this way, the embodiments of the present disclosure can determine not only the image generation configuration information, but also the video generation configuration information, thereby improving the scope of application.

In some embodiments, the process 300 further includes: presenting a plurality of generation templates in the interaction window in response to receiving a fourth operation in the interaction window, each generation template corresponding to preset generation configuration information.

In this way, the embodiments of the present disclosure can support providing a plurality of generation templates for the user to apply the generation configuration information corresponding to the plurality of generation templates to the virtual asset, which eliminates the process of determining the generation configuration information, thereby improving the efficiency of effect editing.

In some embodiments, the process 300 further includes: creating an effect file via the effect editing interface, the effect file being configured to call a media generation service based on the at least one generation parameter to generate corresponding media content during a running process.

In this way, the embodiments of the present disclosure may create the effect file more quickly, thereby improving the efficiency of creating the effect file.

### Example Apparatus and Device

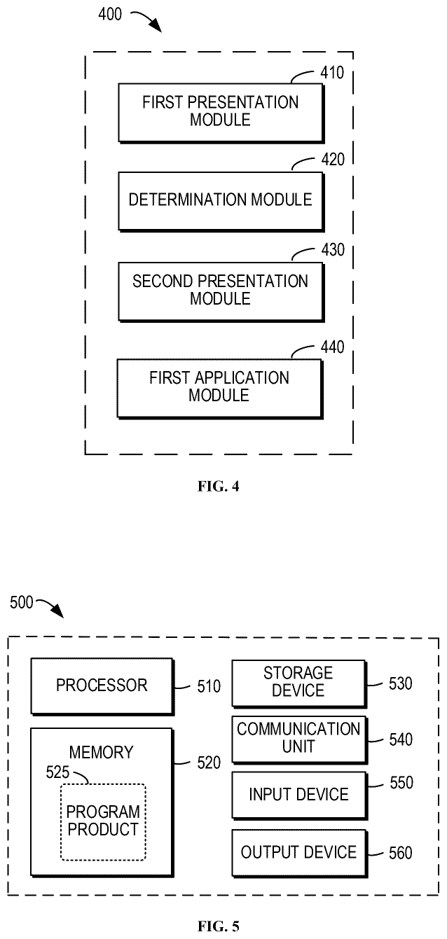

The embodiments of the present disclosure further provide corresponding apparatuses for implementing the above-mentioned methods or processes. FIG. 4 shows a schematic structural block diagram of an example apparatus 400 for effect editing according to some embodiments of the present disclosure. The apparatus 400 may be implemented as or included in the electronic device 110. Each module/component in the apparatus 400 may be implemented by hardware, software, firmware, or any combination thereof.

As shown in FIG. 4, the apparatus 400 includes: a first presentation module 410 configured to present an interaction window in response to receiving a first operation in an effect editing interface; a determination module 420 configured to determine at least one generation parameter via at least one parameter configuration control in the interaction window; a second presentation module 430 configured to present, in the interaction window, first media content generated based on the at least one generation parameter; and a first application module 440 configured to apply generation configuration information to a virtual asset in the effect editing interface in response to receiving a second operation in the interaction window, the generation configuration information corresponding to the at least one generation parameter.

In some embodiments, the at least one parameter configuration control includes a prompt input control, and the at least one generation parameter includes a prompt entered via the prompt input control.

In some embodiments, the interaction window further includes a parameter configuration panel presenting a target parameter configuration control in the at least one parameter configuration control, and the apparatus 400 further includes a second presentation module configured to determine a target generation parameter via the target parameter configuration control; and present an indication element corresponding to the target generation parameter in the prompt input control.

In some embodiments, the apparatus 400 further includes an adjustment module configured to adjust a configuration state of the target parameter configuration control in response to receiving a removal operation for the indication element.

In some embodiments, the target parameter configuration control includes a first control for selecting a model, and the indication element presents identification information of the model determined via the first control.

In some embodiments, the target parameter configuration control includes a second control for setting a reference image, and the indication element presents preview content of at least one reference image configured via the second control.

In some embodiments, the prompt input control is located outside the parameter configuration panel.

In some embodiments, the first presentation module 410 is further configured to: present, in the interaction window, a response message corresponding to the at least one generation parameter, the response message presenting the first media content and at least a part of the at least one generation parameter.

In some embodiments, the first media content is generated based on second media content and the at least one generation parameter, and the second media content includes at least one of: preset media content; or user-configured media content.

In some embodiments, the apparatus 400 further includes a third presentation module configured to present a media configuration interface in response to a selection of a media configuration entry in the interaction window; and determine the second media content via the media configuration interface.

In some embodiments, the determination module 420 is further configured to: present a group of candidate media content; and receive the selection of a second media content in the group of candidate media content.

In some embodiments, the first operation includes the selection of a generation tool in the effect editing interface, and the first application module 440 is further configured to: add a virtual asset of a preset type in the effect editing interface in response to receiving the second operation; and apply the generation configuration information to the added virtual asset.

In some embodiments, the first presentation module 410 is further configured to: present a setting panel of a virtual asset in response to a selection of the virtual asset in the effect editing interface; and present the interaction window in response to a selection of a generation control in the setting panel.

In some embodiments, the first presentation module 410 is further configured to: present an option corresponding to the generation configuration information in the generation control in response to receiving the second operation.

In some embodiments, the first media content includes image content, the at least one generation parameter is a first group of generation parameters, the generation configuration information is configuration information of image generation, and the apparatus 400 further includes an association module configured to associate the image content with a second group of generation parameters for generating video content in response to receiving a third operation on the image content; and present, in the interaction window, the video content generated based on the image content and the second group of generation parameters, the second group of generation parameters corresponding to configuration information of video generation.

In some embodiments, the apparatus 400 further includes a fourth presentation module configured to present a plurality of generation templates in the interaction window in response to receiving a fourth operation in the interaction window, each generation template corresponding to preset generation configuration information.

In some embodiments, the apparatus 400 further includes a creation module configured to create an effect file via the effect editing interface, the effect file being configured to call a media generation service based on the at least one generation parameter to generate corresponding media content during a running process.

The modules included in the apparatus 400 may be implemented in various ways, including software, hardware, firmware, or any combination thereof. In some embodiments, one or more modules may be implemented using software and/or firmware, for example, machine executable instructions stored on a storage medium. In addition to machine executable instructions or as an alternative, some or all units in the apparatus 400 may be implemented at least partially by one or more hardware logic components. As an example, rather than a limitation, example types of hardware logic components that may be used include field programmable gate arrays (FPGA), application specific integrated circuits (ASIC), application specific standards (ASSP), system on chip (SOC), complex programmable logic devices (CPLD), and so on.

FIG. 5 shows a block diagram of an electronic device 500 in which one or more embodiments of the present disclosure may be implemented. It would be appreciated that the electronic device 500 shown in FIG. 5 is only illustrative and should not constitute any limitation to the function and scope of the embodiments described herein. The electronic device 500 shown in FIG. 5 may be used to implement the electronic device 110 as discussed above.

As shown in FIG. 5, the electronic device 500 is in the form of a general electronic device. The components of the electronic device 500 may include but be not limited to one or more processors or processors 510, a memory 520, a storage device 530, one or more communication units 540, one or more input devices 550, and one or more output devices 560. The processor 510 may be an actual or virtual processor and may execute various processes based on the programs stored in the memory 520. In a multi-processor system, a plurality of processors execute computer executable instructions in parallel to improve the parallel processing capability of the electronic device 500.

The electronic device 500 usually includes a plurality of computer storage media. Such media may be any available media that is accessible to the electronic device 500, including but not limited to volatile and non-volatile media, removable and non-removable media. The memory 520 may be a volatile memory (for example, a register, a cache, a random access memory (RAM)), a non-volatile memory (for example, a read-only memory (ROM), an electrically erasable programmable read-only memory (EEPROM), a flash memory), or any combination thereof. The storage device 530 may be a removable or non-removable medium, and may include machine readable media, such as a flash drive, a disk, or any other medium, which may be used to store information and/or data and may be accessed within the electronic device 500.

The electronic device 500 may further include additional removable/non-removable, volatile/non-volatile storage media. Although not shown in FIG. 5, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 520 may include a computer program product 525 having one or more program modules configured to perform various methods or acts of various embodiments of the present disclosure.

The communication unit 540 implements communication with other electronic devices through the communication medium. In addition, the functions of the components of the electronic device 500 may be implemented by a single computing cluster or a plurality of computing machines, which may communicate through the communication connection. Therefore, the electronic device 500 may use a logical connection with one or more other servers, network personal computers (PCs) or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may also communicate with one or more external devices (not shown) through the communication unit 540 as needed, such as a storage device, a display device, etc., communicate with one or more devices that enable the user to interact with the electronic device 500, or communicate with any devices (for example, a network card, a modem, etc.) that enable the electronic device 500 to communicate with one or more other electronic devices. Such communication may be performed via input/output (I/O) interfaces (not shown).

According to an example implementation of the present disclosure, there is provided a computer-readable storage medium having computer executable instructions stored thereon, where the computer executable instructions are executed by a processor to implement the method described above. According to an example implementation of the present disclosure, there is further provided a computer program product, the computer program product being tangibly stored on a non-transitory computer-readable medium and including computer executable instructions, and the computer executable instructions being executed by a processor to implement the method described above.

Various aspects of the present disclosure are described herein with reference to flowcharts and/or block diagrams of methods, apparatuses, devices, and computer program products implemented according to the present disclosure. It would be appreciated that each block in the flowcharts and/or block diagrams, and combinations of blocks in the flowcharts and/or block diagrams, may be implemented by computer-readable program instructions.

These computer-readable program instructions may be provided to a processor of a general-purpose computer, a special-purpose computer, or other programmable data processing apparatus to produce a machine, such that these instructions, when executed by the processor of the computer or other programmable data processing apparatus, create an apparatus for implementing the functions/acts specified in one or more blocks of the flowcharts and/or block diagrams. These computer-readable program instructions may also be stored in a computer-readable storage medium, and these instructions cause the computer, the programmable data processing apparatus, and/or other devices to work in a specific manner, so that the computer-readable medium storing the instructions includes a manufactured product, which includes instructions for implementing various aspects of the functions/acts specified in one or more blocks of the flowcharts and/or block diagrams.

The computer-readable program instructions may be loaded onto a computer, other programmable data processing apparatus, or other devices, so that a series of operation steps are performed on the computer, other programmable data processing apparatus, or other devices to produce a computer-implemented process, thereby enabling the instructions executed on the computer, other programmable data processing apparatus, or other devices to implement the functions/acts specified in one or more blocks of the flowcharts and/or block diagrams.

The flowcharts and block diagrams in the drawings show the possibly implemented architectures, functions, and operations of the systems, methods, and computer program products according to a plurality of implementations of the present disclosure. In this regard, each block in the flowchart or block diagram may represent a module, program segment, or part of instruction, and the module, program segment, or part of instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and the combination of the blocks in the block diagrams and/or flowcharts, may be implemented by a special-purpose hardware-based system that executes specified functions or acts, or may be implemented by a combination of special-purpose hardware and computer instructions.

The implementations of the present disclosure have been described above, and the above description is illustrative, non-exhaustive, and not limited to the disclosed implementations. Without departing from the scope and spirit of the illustrated implementations, many modifications and changes will be apparent to those of ordinary skill in the art. The selection of terms used herein is intended to best explain the principles, the actual applications or improvements to the technologies in the market of the implementations, or to enable other ordinary technicians in the art to understand the implementations disclosed herein.

What is claimed is:

1. A method for effect editing, comprising:
presenting an interaction window in response to receiving a first operation in an effect editing interface;
determining at least one generation parameter via at least one parameter configuration control in the interaction window;
presenting, in the interaction window, first media content generated based on the at least one generation parameter; and
applying generation configuration information to a virtual asset in the effect editing interface in response to receiving a second operation in the interaction window, the generation configuration information corresponding to the at least one generation parameter.

2. The method of claim 1, wherein the at least one parameter configuration control comprises a prompt input control, and the at least one generation parameter comprises a prompt entered via the prompt input control.

3. The method of claim 2, wherein the interaction window further comprises a parameter configuration panel presenting a parameter configuration control in the at least one parameter configuration control, the method further comprising:
determining a generation parameter via the parameter configuration control; and
presenting an indication element corresponding to the generation parameter in the prompt input control.

4. The method of claim 3, further comprising:
adjusting a configuration state of the parameter configuration control in response to receiving a removal operation for the indication element.

5. The method of claim 3, wherein the parameter configuration control comprises a first control for selecting a model, and the indication element presents identification information of the model determined via the first control.

6. The method of claim 3, wherein the parameter configuration control comprises a second control for setting a reference image, and the indication element presents preview content of at least one reference image configured via the second control.

7. The method of claim 3, wherein the prompt input control is located outside the parameter configuration panel.

8. The method of claim 1, wherein presenting in the interaction window the first media content generated based on the at least one generation parameter comprises:
presenting, in the interaction window, a response message corresponding to the at least one generation parameter, the response message presenting the first media content and at least a part of the at least one generation parameter.

9. The method of claim 1, wherein the first media content is generated based on second media content and the at least one generation parameter, and the second media content comprises at least one of:
preset media content; or
user-configured media content.

10. The method of claim 9, further comprising:
presenting a media configuration interface in response to a selection of a media configuration entry in the interaction window; and
determining the second media content via the media configuration interface.

11. The method of claim 9, wherein determining the second media content via the media configuration interface comprises:
presenting a group of candidate media content; and
receiving a selection of the second media content in the group of candidate media content.

12. The method of claim 1, wherein the first operation comprises a selection of a generation tool in the effect editing interface, and applying the generation configuration information to the virtual asset in the effect editing interface in response to receiving the second operation in the interaction window comprises:
adding the virtual asset of a preset type in the effect editing interface in response to receiving the second operation; and
applying the generation configuration information to the added virtual asset.

13. The method of claim 1, wherein presenting the interaction window in response to receiving the first operation in the effect editing interface comprises:
presenting a setting panel of the virtual asset in response to a selection of the virtual asset in the effect editing interface; and
presenting the interaction window in response to a selection of a generation control in the setting panel.

14. The method of claim 13, wherein applying the generation configuration information to the virtual asset in the effect editing interface in response to receiving the second operation in the interaction window comprises:
presenting an option corresponding to the generation configuration information in the generation control in response to receiving the second operation.

15. The method of claim 1, wherein the first media content comprises image content, the at least one generation parameter is a first group of generation parameters, the generation configuration information is configuration information of image generation, and the method further comprises:
associating the image content with a second group of generation parameters for generating video content in response to receiving a third operation on the image content; and
presenting, in the interaction window, the video content generated based on the image content and the second group of generation parameters, the second group of generation parameters corresponding to configuration information of video generation.

16. The method of claim 1, further comprising:
presenting a plurality of generation templates in the interaction window in response to receiving a fourth operation in the interaction window, each generation template corresponding to preset generation configuration information.

17. The method of claim 1, further comprising:
creating an effect file via the effect editing interface, the effect file being configured to call a media generation service based on the at least one generation parameter to generate corresponding media content during a running process.

18. An electronic device, comprising:
at least one processor; and
at least one memory, the at least one memory being coupled to the at least one processor and storing instructions executable by the at least one processor, the instructions, when executed by the at least one processor, causing the electronic device to perform operations comprising:
presenting an interaction window in response to receiving a first operation in an effect editing interface;
determining at least one generation parameter via at least one parameter configuration control in the interaction window;
presenting, in the interaction window, first media content generated based on the at least one generation parameter; and
applying generation configuration information to a virtual asset in the effect editing interface in response to receiving a second operation in the interaction window, the generation configuration information corresponding to the at least one generation parameter.

19. The electronic device of claim 18, wherein the at least one parameter configuration control comprises a prompt input control, and the at least one generation parameter comprises a prompt entered via the prompt input control.

20. A non-transitory computer-readable storage medium having a computer program stored thereon, the computer program being executable by a processor to perform operations comprising:
presenting an interaction window in response to receiving a first operation in an effect editing interface;
determining at least one generation parameter via at least one parameter configuration control in the interaction window;
presenting, in the interaction window, first media content generated based on the at least one generation parameter; and
applying generation configuration information to a virtual asset in the effect editing interface in response to receiving a second operation in the interaction window, the generation configuration information corresponding to the at least one generation parameter.
